(19) United States
(12) Patent Application Publication
(10) Pub. No.: US 2008/0203695 A1
(43) Pub. Date: Aug. 28, 2008

(54) Side mounted ladder rack for pick-up truck having a swinging locking arm

(76) Inventor: William Clinton Bell, Calgary (CA)

Correspondence Address: G. F. Gallinger, 7420 Milner Dr., Colorado Springs, CO, 80920, US

(21) Appl. No.: 11/711,078

(22) Filed: Feb. 27, 2007

(51) Int. Cl. B60R 9/048

(52) U.S. Cl. 280/154

(57) ABSTRACT

A ladder rack to carry a ladder on a pick-up truck having a front and rear rack mounting openings in a top portion of the side wall of the bed box, comprising: a front and a rear ladder support each having, i) an upright insertion portion sized to be closely received within one of the mounting openings in the pick-up truck; ii) a lateral offset portion carried by, and extending inwardly from a top portion of the upright insertion portion; iii) a mast portion carried by an inner end portion of the lateral offset portion; iv) a lateral ladder carrying portion extending laterally from an upper portion of the mast; v) longitudinal movement prevention means to prevent longitudinal movement of the ladder when it is supported on the lateral carrying portions; and, vi) a swinging arm extending from above to below the ladder to limit lateral ladder movement, when a central portion of the swinging arm is maintained in an upright position adjacent to the ladder. In use after the front and rear brackets are inserted within the rack openings, opposite ends of the ladder may be slid over the lateral ladder carrying portions of the supports thereby supporting the ladder parallel to the side wall of the bed; and finally, the swinging arm may be swung to an engaged position to thereby limit lateral movement of the ladder on the lateral carrying portion.

### FIELD OF THE INVENTION

This invention relates to ladder racks which mount into the holes along the bed wall of a pick-up truck. More particularly this invention relates to a ladder rack having a swinging arm which assures retention of the ladder while travelling and which may be locked to prevent ladder theft. The ladder rack also includes a removable top portion which facilitates carrying an additional long extension ladder.

### BACKGROUND OF THE INVENTION

U.S. patent application Ser. No. 11/329,932 made by Wm. Clinton Bell discloses a side mounted ladder rack for a pick-up truck which was carried in the holes along the bed wall in a pick-up truck. Such a ladder rack enables a pick-up truck to secure and carry a ladder without restricting the use of the truck bed. This ladder rack also enables a user to position and remove ladders carried thereon from beside the truck, without climbing into the truck bed. This ladder represented a significant improvement in the convenience and utility of ladder racks for pick-up trucks. One shortfall of the ladder rack disclosed therein was that a ladder carried on the top portion of the rack was not convincingly enough secured thereto. Many users peace of mind mandated that they additionally needed to tie the ladder onto the rack. Another concern was that no provision, other than using a cable and padlock, was made to lock down ladders carried thereon.

### OBJECTS OF THE INVENTION

It is an object of this invention to disclose a ladder rack for a pick-up truck on which a ladder may be positioned and secured without having to climb up into the truck box while carrying the ladder. It is an object of this invention to disclose a ladder rack for a truck which does not interfere with use of the interior space of the truck box. It is yet a further object of this invention to disclose a ladder rack which when not in use is sufficiently compact so that it may be stored behind the truck seat, and which may be conveniently mounted on, or removed from use on a pick-up truck without having to climb into the truck box. Many individuals need to carry a ladder only on an occasional basis. It is yet a further object of this invention to disclose a ladder rack having a removable top portion which may be quickly seated on, or removed from a bottom portion of the rack while mounted on the truck. The removable top portion facilitates carrying a long extension ladder over the cab of the truck. It is a final object of this invention to disclose a ladder rack having a swinging arm which positively holds ladders on the rack. The swinging arm not only provides comforting assurance that the carried ladders are unshakably secured to the rack, but additionally includes a key lockable pin which prevents ladder theft off the rack. There is no need to carry a padlock and cables to wrap through the ladders and around the rack, to prevent removal of a ladder from the ladder rack.

One aspect of this invention provides for a ladder rack to carry a ladder on a pick-up truck having a front and rear rack mounting openings in a top portion of the side wall of the bed box, comprising: a front and a rear ladder support each having, i) an upright insertion portion sized to be closely received within one of the mounting openings in the pick-up truck; ii) a lateral offset portion carried by, and extending inwardly from a top portion of the upright insertion portion; iii) a mast portion carried by an inner end portion of the lateral offset portion; iv) a lateral ladder carrying portion extending laterally from an upper portion of the mast; v) longitudinal movement prevention means to prevent longitudinal movement of the ladder when it is supported on the lateral carrying portions; and, vi) a swinging arm extending from above to below the ladder to limit lateral ladder movement, when a central portion of the swinging arm is maintained in an upright position adjacent to the ladder. In use after the front and rear brackets are inserted within the rack openings, opposite ends of the ladder may be slid over the lateral ladder carrying portions of the supports thereby supporting the ladder parallel to the side wall of the bed; and finally, the swinging arm may be swung to an engaged position to thereby limit lateral movement of the ladder on the lateral carrying portion.

Various other objects, advantages and features of this invention will become apparent to those skilled in the art from the following description in conjunction with the accompanying drawings.

### FIGURES OF THE INVENTION

FIG. 1 is a perspective view of a pick-up truck having a passenger side mounted ladder rack carrying a ladder. The ladder rack comprises similar front and rear supports.

FIG. 2 is a perspective view of a bottom portion of the front ladder support shown in FIG. 1. The front ladder rack has an offset arm which bends downwardly for reception within the front mounting opening in a top portion of the side wall of the bed box.

FIG. 3 is an enlarged perspective view of an optional C-clamp used to secure the ladder lack to the bed wall of the pick-up truck.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

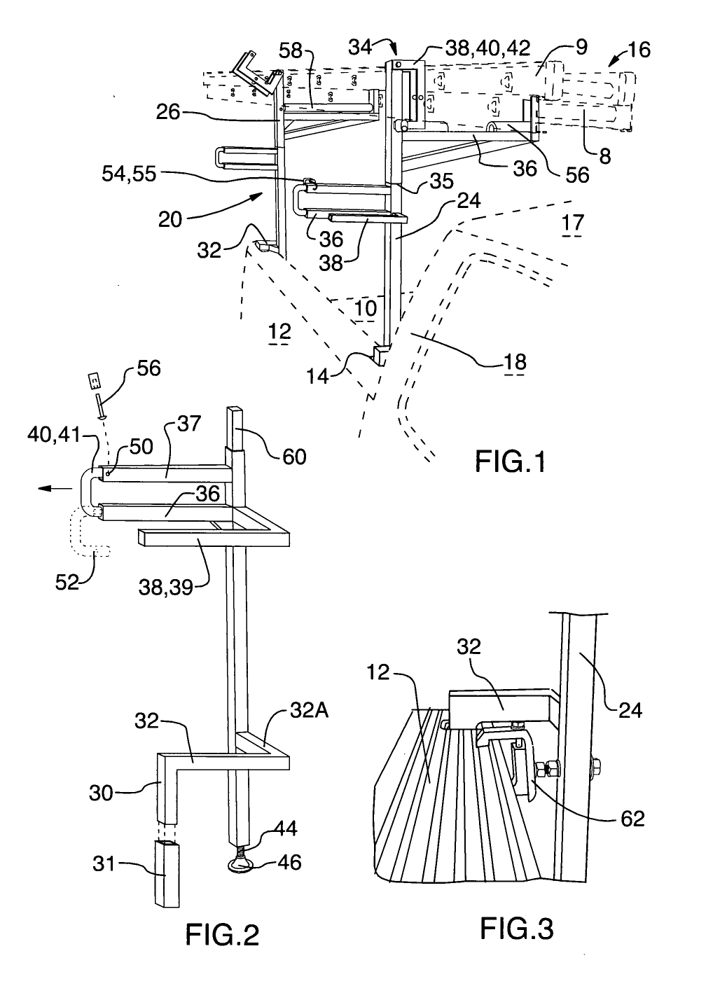

Turning now to the drawings and more particularly to FIG. 1 we have a perspective view of a pick-up truck 18 having a passenger side mounted ladder rack 20 carrying a ladder 16. The ladder rack 20 comprises similar front 24 and rear 26 supports. Most generally, a ladder rack 20 to carry a ladder 16 on a pick-up truck 18 having a front and rear rack mounting openings 14 in a top portion of the side wall 12 of the bed box 10, comprises: a front 24 and a rear ladder support 26 each having, i) an upright insertion portion 30 sized to be closely received within one of the mounting openings 14 in the pick-up truck 18; ii) a lateral offset portion 32 carried by, and extending inwardly from a top portion of the upright insertion portion 30; iii) a mast portion 34 carried by an inner end portion of the lateral offset portion 32; iv) a lateral ladder carrying portion 36 extending laterally from an upper portion of the mast 34; v) longitudinal movement prevention means 38 to prevent longitudinal movement of the ladder 16 when it is supported on the lateral carrying portions 36; and, vi) a swinging arm 40 extending from above to below the ladder 16 to limit lateral ladder 16 movement, when a central portion of the swinging arm 40 is maintained in an upright position adjacent to the ladder 16. In use after the front 24 support and rear 26 ladder support are inserted within the rack openings 14, opposite ends of the ladder 16 may be slid over the lateral ladder carrying portions 36 of the supports 24,26 thereby supporting the ladder 16 parallel to the side wall 12 of the bed 10; and finally, the swinging arm 40 may be swung to an engaged position to thereby limit lateral movement of the ladder 16 on the lateral carrying portion 36.

FIG. 2 is a perspective view of a bottom portion of the front ladder support 24 shown in FIG. 1. The front ladder support has an offset arm 32 which bends downwardly for reception within the front mounting opening 14 in a top portion of the side wall 12 of the bed 10. In the most preferred embodiment of the invention the ladder rack 20 has a lower end portion of the mast 34 which comprises a longitudinally extending screw 44 terminating in a bed foot 46 so that portion of the mast 34 extending beneath the lateral offset portion 32 may be adjusted for height so that the lateral offset portion 32 extending from the mast can be maintained in an installed position which is marginally above the top portion of the side wall 12 of the bed 10. Most preferably the upright insertion portion 30 of the support 24,26 is adapted to be received in a smaller sized side wall 12 opening 14, and wherein the upright insertion portion 30 further comprises a plastic sleeve 31 having interior dimensions to fit closely around the upright insertion portion 30 of the supports 24,26, and having exterior dimensions so that the sleeve 31 covered upright insertion portion 30 is closely received within a larger sized side wall 12 opening 10, so that the support 24,26 can fit closely within the smaller opening 14 without the plastic sleeve 31, and closely within the larger opening 14 with the use of the plastic sleeve 31. The front support of the ladder rack shown in FIG. 2 is adapted for use in a pick-up truck having a front rack opening which is relatively closer to a front end of the sidewall of the bed box. It further comprises a longitudinal offset portion 32A extending between and separating the inner end portion of the lateral offset portion 32 and a lower end portion of the mast 34 of the front ladder support 24, so that when the ladder 16 is positioned over the ladder carrying portions 36 of the mounted supports 24,26 the ladder 16 is shifted rearwardly along the side wall 12 of the bed 10 thereby overcoming the difficulty of the opening 14 being relatively close to the cab end of the side wall 12 of the bed 10. In a preferred aspect of the invention a lower end portion of the mast 34 comprises a longitudinally extending screw 44 terminating in a bed foot 46 so that portion of the mast 34 extending beneath the lateral offset portion 32 may be adjusted for height so that the lateral offset portion 32 is maintained in an installed position which is marginally above the top portion of the side wall 12 of the bed 10.

FIG. 2 also shows an aspect of the invention wherein the lower portion of the ladder rack 20 wherein the longitudinal movement prevention means 38 comprises a parallel arm 39 longitudinally spaced from the ladder carrying portion 36 so that a rung 8 on the ladder 16 can be positioned between it and the ladder carrying portion 36 to thereby prevent longitudinal shifting of the ladder 16. The ladder carrying portion 36 herein extends away from the truck 18. The rack further 20 comprises an upper lateral portion 37 adjacent and generally parallel to, and spaced above the lateral carrying portion 36. In this aspect of the invention the swinging arm 40 comprises a U shaped member 41 having one end portion pivoted on and within an outer end portion of the lower lateral carrying portion 36. The other end thereof is configured to releasably engage an outer end portion of the upper lateral portion 37, so that when engaged, a ladder 16 seated on the lateral carrying portion 36 is prevented from moving laterally. In the most preferred embodiment of the invention the swinging arm 40 is sprung inwardly to towards the mast 34 within the lateral ladder carrying portion 36, and the other end portion of the U shaped member 41 is received within an outer end portion of the upper lateral portion 37 so that to disengage the U shaped member 41 it must first be sprung outwardly out of the outer end portion of the upper lateral portion 41.

Most preferably the ladder carrying portion 36 has sufficient length to carry two ladders 16 thereon. Most preferably a bore 52 extending through an end portion of the swinging arm 40 and a pair of holes 50 aligned with the bore 52 are provided so that a pin 54 may be positioned through the holes 50 and bore 52 to maintain the swinging arm 40 in an engaged position. If the pin 51 comprises one of a lock shackle 55 and a lockable receiver hitch pin 56, the swinging arm may be locked in an engaged position to prevent unauthorized removal of the ladder 16 from the rack 20. In the most preferred embodiment of this aspect of the invention the lateral ladder carrying portion 36 is marginally sloped so that a ladder 16 resting thereon will slide inwardly thereon, to and against the mast 34.

Refer back to FIG. 1. Look at the top portion of the supports 24,26. The lateral ladder carrying portion 36 extends inwardly above the cab 17 of the truck 18. The swinging arm 38 therein comprises two similar U shaped swinging arms 40, each having an end portion adjacently pivoted to a top portion of the mast 34 above the lateral ladder carrying portion 26. Each has the other end thereof configured to releasably engage a central portion of the mast 34, so that they together can swing down over and around both a rung 8 and side rail 9 of the ladder 16 seated on the lateral carrying portion 36 of the rack 20, said swinging arm 40 thereby functioning as the longitudinal movement prevention means which additionally positively attach the ladder 16 to the rack 20. Similarly to the description above, the central portion of the mast 34 has a bore 52 therethrough and the U shaped members 40 comprise plates 42 having a central spacer 43 and having holes 50 through their swinging ends portions so that a pin 54 can extend through the holes 50 and bore 52 to maintain the swinging arms 40 in an engaged position. If the pin 54 comprises one of a lock shackle 55 and a locking hitch pin 56 then the swinging arms 40 can be locked in an engaged position preventing unauthorized removal of the ladder 16 from the rack 20.

Still referring to FIG. 1, in the most preferred embodiment of the invention a top portion of the lateral ladder carrying portion 36 on the front rack support 24 further comprises a rubber bumper 56 to prevent rattling of the ladder 16 seated thereon, and wherein a top portion of the lateral ladder carrying portion 36 on the rear support 26 further comprises a rubber roller 58 to facilitate loading of a ladder 16 from behind the truck 18.

In the most preferred embodiment of the invention the mast 34 is broken 35 between an upper and a lower portion, one of said portions has an inner joining member 60 extending therefrom so that the upper portion of the mast, 34 need only be shifted vertically to remove or attach it to the lower portion installed on the truck 18, thereby facilitating such easy removal and attachment thereof that said upper portion of the rack 20 need only be carried on the truck 18 when a long ladder 16 is needed.

FIG. 3 is an enlarged perspective view of an optional C-clamp 62 used to secure the ladder rack to the bed wall 12 of the pick-up truck 18. The C clamp 62 is attached to the mast 34 adjacent to the lateral offset portion 32. Said C clamp is configured to grip above and beneath the top portion of top portion of the side wall 12 of the bed 10 to thereby provide additional stability of the rack 20 mounted on the truck 18.

While the invention has been described with preferred specific embodiments thereof, it will be understood that this description is intended to illustrate and not to limit the scope of the invention, which is defined by the following claims.

I claim:

1) A ladder rack to carry a ladder on a pick-up truck having a front and rear rack mounting openings in a top portion of the side wall of the bed box, comprising:
a front and a rear ladder support each having,
i) an upright insertion portion sized to be closely received within one of the mounting openings in the pick-up truck;
ii) a lateral offset portion carried by, and extending inwardly from a top portion of the upright insertion portion;
iii) a mast portion carried by an inner end portion of the lateral offset portion;
iv) a lateral ladder carrying portion extending laterally from an upper portion of the mast;
v) longitudinal movement prevention means to prevent longitudinal movement of the ladder when it is supported on the lateral carrying portions; and,
vi) a swinging arm extending from above to below the ladder to limit lateral ladder movement, when a central portion of the swinging arm is maintained in an upright position adjacent to the ladder;
wherein use after the front and rear brackets are inserted within the rack openings, opposite ends of the ladder may be slid over the lateral ladder carrying portions of the supports thereby supporting the ladder parallel to the side wall of the bed; and finally, the swinging arm may be swung to an engaged position to thereby limit lateral movement of the ladder on the lateral carrying portion.

2) A ladder rack as in claim 1 wherein a lower end portion of the mast comprises a longitudinally extending screw terminating in a bed foot so that portion of the mast extending beneath the lateral offset portion may be adjusted for height so that the lateral offset portion is maintained in an installed position which is marginally above the top portion of the side wall of the bed.

3) A ladder rack as in claim 1 wherein an upright insertion portion of the support is adapted to be received in a smaller sized side wall opening, and wherein the upright insertion portion further comprises a plastic sleeve having interior dimensions to fit closely around the upright insertion portion of the supports, and having exterior dimensions so that the sleeve covered upright insertion portion is closely received within a larger sized side wall opening, so that the support can fit closely within the smaller opening without the plastic sleeve, and closely within the larger opening with the use of the plastic sleeve.

4) A ladder rack as in claim 1, adapted for use in a pick-up truck having a front rack opening which is relatively closer to a front end of the sidewall of the bed box further comprising a longitudinal offset portion extending between and separating the inner end portion of the lateral offset portion and a lower end portion of the mast portion of the front ladder support, so that when the ladder is positioned over the ladder carrying portions of the mounted supports the ladder is shifted rearwardly along the side wall of the bed box thereby overcoming the difficulty of the rack opening which is relatively close to the cab end of the side wall of the bed.

5) A ladder rack as in claim 1 wherein the longitudinal movement prevention means comprises a parallel arm longitudinally spaced from the ladder carrying portion so that a rung on the ladder can be positioned between it and the ladder carrying portion to thereby prevent longitudinal shifting of the ladder; and wherein the ladder carrying portion extends away from the truck and wherein the rack further comprises an upper lateral portion adjacent and generally parallel to, and spaced above the lateral carrying portion.

6) A ladder rack as in claim 5 wherein the swinging arm comprises a U shaped member having one end portion pivoted on and within an outer end portion of the lower lateral carrying portion, and having the other end thereof configured to releasably engage an outer end portion of the upper lateral portion, so that when engaged, a ladder seated on the lateral carrying portion is prevented from moving laterally.

7) A ladder rack as in claim 6 wherein the swinging arm is sprung inwardly to towards the mast within the lateral ladder carrying portion, and wherein the other end portion of the U shaped member is received within an outer end portion of the upper lateral portion so that to disengage the U shaped member it must first be sprung outwardly out of the outer end portion of the upper lateral portion.

8) A ladder rack as in claim wherein the ladder carrying portion has sufficient length to carry two ladders thereon.

9) A ladder rack as in claim 6 further comprising a bore extending through an end portion of the swinging arm and a pair of holes aligned with the bore so that a pin may be positioned through the holes and bore maintaining the swinging arm in an engaged position.

10) A ladder rack as in claim 9 wherein the pin comprises one of a lock shackle and a lockable receiver hitch pin, to lock the swinging arm in an engaged position to prevent unauthorized removal of the ladder from the rack.

11) A ladder rack as in claim 5 wherein the lateral ladder carrying portion is marginally sloped so that a ladder resting thereon will slide inwardly thereon, to and against the mast.

12) A ladder rack as in claim 1 wherein the lateral ladder carrying portion extends inwardly above the cab of the truck and wherein the swinging arm comprises two similar U shaped swinging arms, each having an end portion adjacently pivoted to a top portion of the mast above the lateral ladder carrying portion, and having the other end thereof configured to releasably engage a central portion of the mast, so that they together can swing down over and around both a rung and side rail of the ladder seated on the lateral carrying portion of the rack, said swinging arm thereby functioning as the longitudinal movement prevention means which additionally positively attaching the ladder to the rack.

13) A ladder rack as in claim 12 wherein the central portion of the mast has a bore therethrough and wherein the U shaped members comprise plates having a central spacer and having holes through their swinging ends portions so that a pin can extend through the holes and bore to maintain the swinging arms in an engaged position.

14) A ladder rack as in claim 13 wherein the pin comprises one of a lock shackle and a locking hitch pin so that the swinging arms can be locked in an engaged position preventing unauthorized removal of the ladder from the rack.

15) A ladder rack as in claim 12 wherein a top portion of the lateral ladder carrying portion on the front support further comprises a rubber bumper to prevent rattling of the ladder seated thereon, and wherein a top portion of the lateral ladder carrying portion on the rear rack support further comprises a rubber roller to facilitate loading of a ladder from behind the truck.

16) A ladder rack as in claim 5 and 12 wherein the mast is broken between an upper and a lower portion, one of said portions having an inner joining member extending therefrom so that the upper portion of the mast need only be shifted vertically to remove or attach it to the lower portion installed on the truck, thereby facilitating such easy removal and attachment thereof that said upper portion of the rack need only be carried on the truck when a long ladder is needed.

17) A ladder rack as in claim 5 further comprising a C clamp attached to the mast adjacent to the lateral offset portion, said C clamp configured to grip above and beneath the top portion of top portion of the side wall of the bed to thereby provide additional stability of the rack mounted on the truck.

18) A ladder rack as in claim 12 further comprising a C clamp attached to the mast adjacent to the lateral offset portion, said C clamp configured to grip above and beneath the top portion of top portion of the side wall of the bed to thereby provide additional stability of the rack mounted on the truck.
